(19) United States
(12) Patent Application Publication
(10) Pub. No.: US 2006/0168054 A1
(43) Pub. Date: Jul. 27, 2006

(54) Messaging method and apparatus

(75) Inventors: Daniel Burkhart, San Francisco, CA (US); Dheeraj Singh Mohnia, Pato Alto, CA (US)

Correspondence Address: SCHWEGMAN, LUNDBERG, WOESSNER & KLUTH, P.A., P.O. BOX 2938, MINNEAPOLIS, MN, 55402, US

(73) Assignee: eBay Inc.

(21) Appl. No.: 11/172,721

(22) Filed: Jun. 30, 2005

Related U.S. Application Data
(60) Provisional application No. 60/635,856, filed on Dec. 13, 2004.

(51) Int. Cl. G06F 15/16

(52) U.S. Cl. 709/206

(57) ABSTRACT

A method and instant messaging client are provided to receive personalized content via an instant message. The method may include retrieving content identification criteria stored at the instant messaging client and communicating the content identification criteria via the instant messaging client to an instant messaging server. The instant messaging server may be arranged to provide content associated with the content identification criteria. The method may include receiving the associated content via an instant message and displaying the content via the instant messaging client.

### RELATED APPLICATION

This application claims priority under 35 U.S.C. 119(e) from U.S. Provisional Application Ser. No. 60/635,856 filed 13 Dec. 2004, which application is incorporated herein by reference.

### TECHNICAL FIELD

The field of the invention relates generally to real-time communications or instant messaging (IM).

### BACKGROUND

The advent of the Internet combined with the development of network-based commerce system applications have enabled companies to transact business globally in real-time. This technology has spawned a host of online or virtual stores offering goods and/or services (products) via the Internet. In order to promote sales via these online websites sites, online stores regularly send advertising emails promoting their products to users. As is the case with all email, these advertising emails are received in a user's inbox for reading at their leisure. Often users merely delete these advertising emails without even opening them.

The Internet has also resulted in new methods whereby people communicate with one another (e.g., in a one-to-one manner and one-to-many manner). The most popular of these methods is Instant Messaging (IM). Major online services, such as America Online (AOL), MSN, and Yahoo, are examples of providers of IM services. These service providers have created online communities of chat rooms and people exchanging instant messages (including peer-to-peer messages and multicast messages). A chat room is software that allows a group of people to type in messages that are seen by everyone in the “room,” while Instant Messaging is basically a chat room for just two people.

### SUMMARY

A method and system for real-time communication or Instant Messaging (IM) is described. In one example embodiment, personalized content is sent to a real-time client (e.g., an IM client) based on criteria stored on a client device. The criteria may be personalized or preferences criteria such as search terms, product identification data (e.g., listings of interest in a network-based commerce system), or any other identifier to identify content to be sent via an IM. For the purposes of this specification, the term “Instant Messaging” should be interpreted broadly to include any messaging system that may be an active or persistent application provided on an electronic device (e.g., a desktop of a computer, a cellular telephone, a set-top box, or the like).

### BRIEF DESCRIPTION OF THE DRAWINGS

FIG. 1 shows a block diagram of an example instant messaging system, in accordance with the invention.

FIG. 2 shows a flow diagram of a method, in accordance with the invention, to provide personalized IM content to a user.

FIG. 3 shows an example graphical user interface generated by an IM client, also in accordance to the invention.

FIG. 4 shows an example search results page modified and presented to a user via the IM system.

FIG. 5A shows example IM criteria included in an IM request.

FIG. 5B shows a block diagram of an example messaging client, in accordance with the invention.

FIG. 5C shows a block diagram of an example content provider application, in accordance with the invention.

FIG. 6 is a diagram of an example network-based commerce system or facility, also in accordance with the invention, deploying the methods or systems of embodiments associated with the invention.

FIG. 7 is a database diagram illustrating an example database, which at least partially implements and supports the network-based commerce system of FIG. 6.

FIG. 8 is a diagram of an example listing table associated with the database of FIG. 7.

FIG. 9 is a diagram of an example users table associated with the listing table of FIG. 8 and the database of FIG. 7.

FIG. 10 is a diagrammatic representation of a machine in the example form of a computer system within which a set or sequence of instructions, for causing the machine to perform any one of the methodologies discussed herein, may be executed.

### DETAILED DESCRIPTION OF THE DRAWINGS

Referring to the drawings, reference numeral 10 generally indicates an Instant Messaging (IM) system in accordance to the invention. The system 10 includes an instant message (IM) server 12, a plurality of IM content providers 14 one or more of which may be an electronic marketplace 16 that may, for example, provide a plurality of listings offering goods and/or services for sale. For example, as described in more detail below, the electronic marketplace 16 may be a facility such as eBay, Inc. The IM content providers 14 may be any IM content providers including networked-based commerce platforms or electronic marketplaces. For the purposes of this specification, the term “Instant Messaging” should be interpreted broadly to include any messaging system that may be active or a persistent (running all the time—“real-time”) application provided on an electronic device (e.g., a desktop of a computer, a set-top box, a cellular telephone or the like). Thus, use of the term is intended to include functionality in which messages are communicated between devices and presented to a user relatively quickly (occurring almost immediately in some instances). This may be contrasted with an email scenario where an email may be sent to an email box where the email may reside for some time before a user opens it. The term instant messaging IM is thus intended to include any type of communications service that enables a user to communicate in real-time (occurring almost immediately) over the Internet (or any other communication channel such as cellular telephone network), analogous to a telephone conversation but using text-based, not voice-based, communication.

The system 10 further includes a plurality of client devices 18 which are connected via a network 20 to the IM server 12, IM content providers 14, and the electronic marketplace 16. It will be appreciated that further client devices 18 may be provided which maybe connected or networked via the network 20 in a wireless or wired fashion. In one example embodiment, the network 20 is the Internet and the client devices 18 are personal computers or the like. In addition or instead, the client devices 18 may be cellular telephones, personal digital assistants (PDA), or any other electronic device that may communicate via a communication network, for example, a cellular network.

A client application 21 may be provided on each client device 18. The client application 18 may include an IM application 22 and content identification criteria in the exemplary form of IM criteria 24. The content identification criteria/IM criteria 24 maybe personalized criteria selected by a particular user and, in one example embodiment, the IM criteria 24 are included as part of the IM application 22. It will, however, be appreciated that the IM criteria 24 maybe provided in any storage device on a client device 18 (or stored on the IM server 12). As described in more detail below, in one example embodiment the IM application 22 is a client-side application provided by an instant messaging desktop application. Each time a user opens the desktop IM client 21, a request (e.g., an HTTP request) maybe initiated and personalized IM criteria 24 may accompany the request. The request may then be communicated to the IM server 12. In certain embodiments, the IM server 12 may form part of the electronic marketplace 16 or any of the other IM content providers 14. In response to the IM request, any one or more of the IM content providers 14 or the electronic marketplace 16 may push personalized content to the specific IM client 21 from which the request was received. The IM client 21 may be a persistent application that runs continually on a desktop of the client device 18 and may thus always be active when the client device 18 is on. In one example embodiment, the IM client 21 is Javascript-based. From a client perspective, the IM criteria 24 may thus define content which is pulled by the IM client 21.

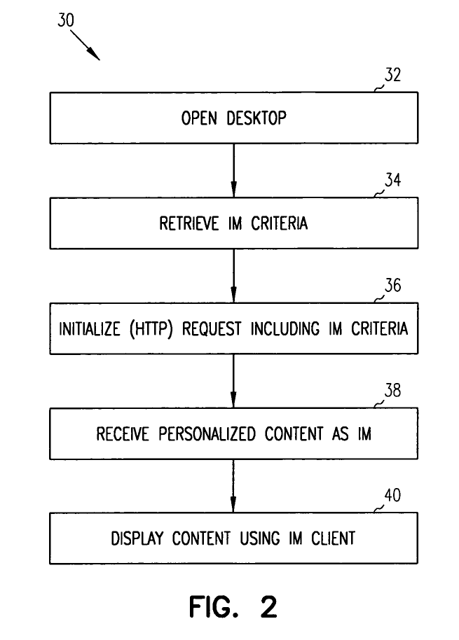

Referring to FIG. 2, reference numeral 30 generally indicates a method, in accordance with an embodiment, to provide personalized IM content to a user. As shown at operation 32, the method 30 begins when a user opens a desktop instant messaging client 21 where after, the method 30 retrieves the IM criteria 24 from a storage location provided at the client device 18 (see operation 34). Thereafter, the IM application 22 initializes a request (e.g., an HTTP request) including the IM criteria 24 retrieved from the personalized IM criteria storage location (see operation 36). The request may be sent to the IM server 12 or any one or more of the IM providers 14 and electronic marketplace 16 dependent upon the configuration of the request and server equipment provided at the IM providers 14 and electronic marketplace 16.

For example, assuming that the request is sent to an IM content provider 14, upon receipt of the request the IM content provider 14 then provides or communicates personalized content to the IM application 22 based upon the IM criteria 24 in the request. Upon receipt of the personalized content as an IM (see operation 38), the IM application 22 displays the content to a user as shown at operation 40. Thus, in one example embodiment, the system 10 may automatically push IM content to a user where the user can define the content being pushed by defining the IM criteria 24.

For example, the personalized IM criteria 24 may be preferred search terms, which are included in the IM request received by the IM content provider 14 or electronic marketplace 16. Upon receipt of the search terms, the IM content provider 14 or electronic marketplace 16 may then conduct a search using the search terms and communicate the results thereof via an IM to the IM application 22. For example, in a network-based commerce facility such as eBay, Inc. that provides a plurality of listings offering goods and/or services for sale, the IM content provider 14 or the electronic marketplace 16 may then search listings and, based on the search terms (e.g., IM criteria 24) received from the IM application 22, provide appropriate listings that are found to the user.

In one example embodiment, the IM criteria 24 are stored on the client device 18. For example, the IM criteria may be stored in a cookie (e.g., including text defined by the user) on the client device 18. For example, the IM application 22 may provide a user interface where a user enters text that defines user preferences or IM criteria 24 where after a cookie is generated and stored on the client device 18. Thus, the user may, in an embodiment, define content communicated to him/her in an IM environment.

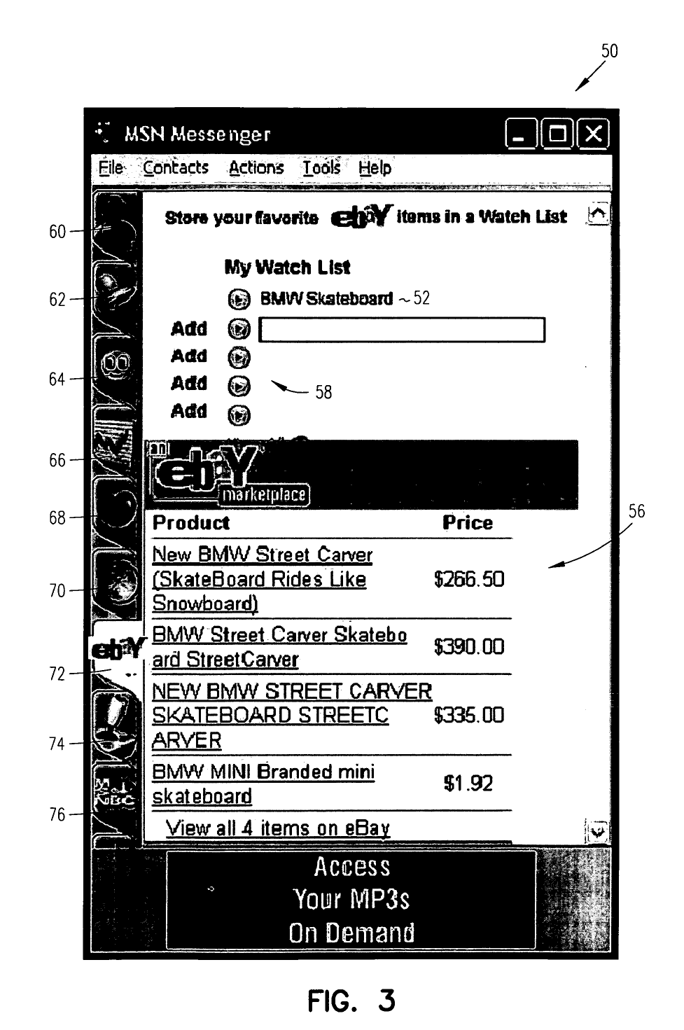

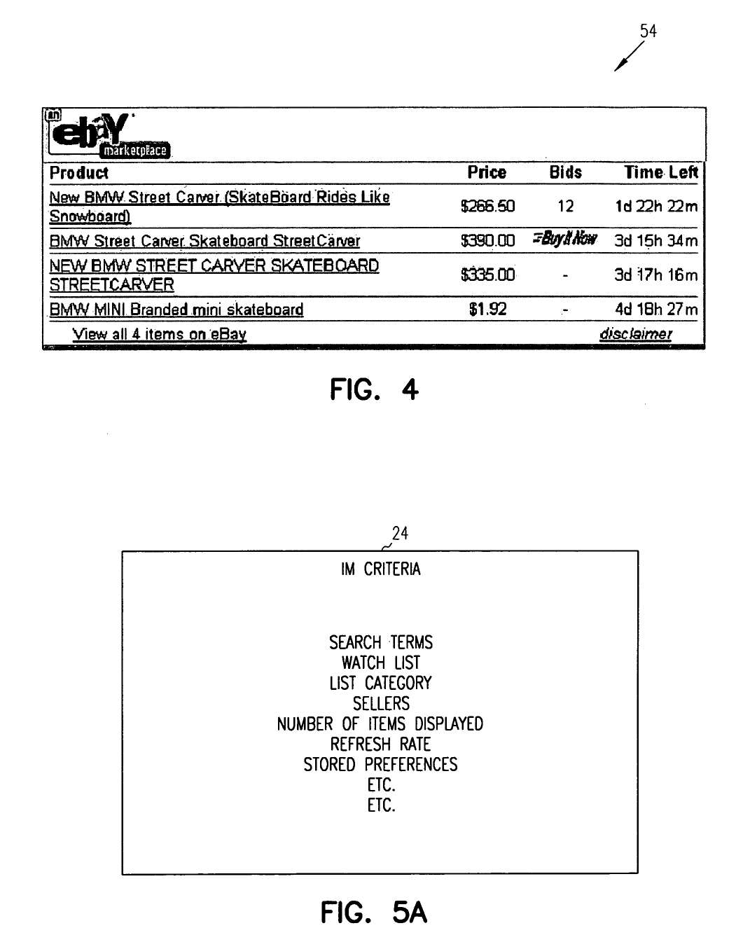

For example, the IM application 22 may generate a user interface 50 (see FIG. 3), which allows a user to define personalized search criteria (e.g. a BMW Skateboard 52). When the IM application 22 is open, an HTTP request is then sent with the criteria (“BMW skateboard”) to the IM server 12. When the electronic marketplace 16 includes IM functionality, the request may be then sent (e.g., directly) to the electronic marketplace 16. The electronic marketplace 16 may, in turn, conduct a search using the terms received from the IM client 21 (e.g., “BMW skateboard”) as search terms. In response to such a search, the electronic marketplace 16 may locate a plurality of listings. Following on with the “BMW skateboard” example, the electronic marketplace may locate listings 54 (see FIG. 4) in response to the search. The electronic marketplace 16 may then include an instant message generation module, which generates an instant message including the listings 54, which is then sent to the client device 18 for display. The client device 18 may, in turn, display the listings in an instant message window. IM window 56 is an example of such window.

When the IM criteria 24 are provided by a cookie, upon opening the IM client 21, a javascript may read the cookie (which may be a text file) and insert the contents of the cookie (e.g., text) into an HTTP request (or a request using any other protocol) and send it to the IM server 12, IM content providers 14 or electronic marketplace 16. Thus, in one example embodiment, the IM request is created dynamically based on IM criteria 24 defined by the user. The IM criteria 24 may thus be uniquely defined by a user and the IM request is thus not a predefined request.

In another embodiment, the IM server 12 may extract the IM criteria 24 from a request it receives from the IM client 21 and send the criteria to an IM content provider 14 or the electronic marketplace 16. The IM content provider 14 or the electronic marketplace 16 may then return the content to the IM server 12 which then communicates the identified content via an IM to the client device 18. It will be appreciated that the IM content provider 14 or the electronic marketplace 16 may send the identified content in an IM directly to the client device 18.

The graphical user interface (GUI) 50 may provide various other options to a user to add additional personalized criteria as shown at 58. In addition, optionally, the graphical user interface 50 may provide all functionality provided by conventional instant messaging systems such as those provided by AOL Instant Messenger (AIM), MSN Messenger, Yahoo Instant Messenger, or the like.

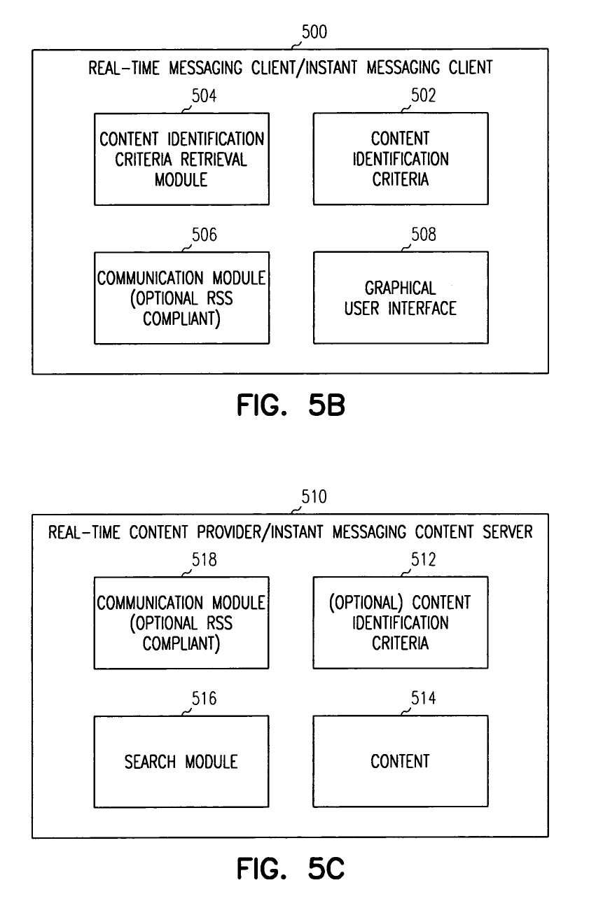

As described above, in an example embodiment the IM criteria 24 are search terms. In addition or instead, the IM criteria 24 may be a category of listings in an electronic marketplace (e.g., a category of listings available on eBay.com, Amazon.com, or the like); the criteria may identify various online stores or sellers of interest; the criteria may identify a number of listings or content items to be displayed; or any other content identifier. FIG. 5A shows example IM criteria 24 that may be stored locally on the client device 18. The IM criteria 24 are shown by way of example to include search terms, “watch list”, at least one listing category, one or more sellers, a number of listings/items (products and/or services) to be displayed, a refresh rate, stored preferences and any other criteria or identifiers that a user may define to identify IM content to be viewed.

The “watch list” (as used by eBay.com and equivalent to a “wish list” as used by other online vendors) may be items or listings a user has indicated to be of interest to him/her. The refresh rate may allow a user to define how frequently the IM client 21 is to be updated by the IM content provider (e.g., how frequently the electronic marketplace 16 provides update data to the client device 18). It will be appreciated that if the refresh rate is set by a user to be high or very frequent, the user may obtain almost real-time updates of content identified by the IM criteria 24.

The GUI 50 may include a plurality of tabs 60-76 to allow a user to view different content. The tab 72 may allow the user to define IM criteria 24 in accordance with the present invention. Unlike tabs 60-70 and 74-74 that require an active action by the user to refresh or update information provided via the tab, the tab 72 opens a window that is automatically refreshed by instant messages from an IM content provider based on the IM criteria 24 which the user defines and which, in an embodiment, are stored on the client device 18.

In an example embodiment, the IM client 21 is included within an “Editor's Kit” application as provided by eBay, Inc. The Editors Kit application may be downloaded onto the client device 18 and allows a user to edit listings in an online transaction environment (e.g., in a bulk fashion). In this embodiment utilizing the IM client 21, a user (as opposed to a provider of listings) may define IM content displayed in an IM window or any other graphical user interface. As the user is free to define the IM criteria 24 (e.g., define any search term or other IM criteria), the system 10 allows the user to define the level of particularity or detail which the IM content provider searches or provides IM content to the user. For example, in the network-based commerce facility described below, a user may define IM criteria 24 including several search criteria so as to narrow down the IM content sent to the user. If the user is interested in monitoring listings of a particular musical group, the IM criteria may be “CD U2 How to Dismantle an Atomic Bomb.” It will thus be appreciated, that a user may specify the level of detail used to identify IM content sent to the user. The user may thus not be restricted to predefined search terms or IM content identifiers but may be free to define any personalized IM content identifier/identification or IM criteria. The IM criteria 24 may thus be highly granular.

The IM content sent by the IM server 12, IM content provider 14, and/or electronic marketplace 16 may be in XML, HTML or any other format/protocol. For example, when the IM content is provided by the IM server 12, IM content provider 14, or electronic marketplace 16 is XML the IM client 21 may process the data so as to render it to a user in an appropriate fashion (e.g., with an appropriate look and feel). In one example embodiment, the client device 18 includes an RSS (Really Simple Syndication) reader to provide RSS functionality. When the IM content is sent using HTML, the IM client 21 may include browser-type functionality to facilitate display of the IM content.

As mentioned above, the invention is not restricted to instant messaging (IM) in its narrow sense. The term IM is used in this specification is intended to include any persistent application running continuously in the background on a client device. The term instant messaging IM is thus intended to include any type of communications service that enables a user to communicate in real-time (occurring almost immediately) over the Internet, a cellular telephone network, or the like and analogous to a telephone conversation but using text-based, not voice-based, communication. In different embodiments, the system 10 may use different file formats to communicate the content and the content identification criteria (e.g., RSS, XML, HTML or the like).

FIG. 5B shows an example messaging client 500, in accordance with an example embodiment, for communicating content identification criteria 502 to a content provider server application 510. Communication between the messaging client 500 and the content provider server application 510 may occur in real-time by way of a conventional instant message (e.g., an instant message suitable for use in AOL's instant messaging client (AIM), MSN Messenger, Yahoo Instant Messenger, or the like), a cellular telephone message or the like. In certain embodiments, the communications may take place without any significant delay but without human intervention (e.g., the opening of an email message by a user at will).

The messaging client 500 is shown by way of example to include a content identification retrieval module 504 that operatively retrieves personalized content identification criteria 502. A communication module 506 (e.g., configured for RSS, conventional Instant Messages, or the like) is provided to communicate with a content provider in real-time (or near real-time).

The content provider server application 510 in FIG. 5C is shown optionally to include personalized content identification criteria 512, content 514 (e.g., listing in a network-based commerce facility), and a search module 516 to search the content 514 based on the content identification criteria 512 and/or 502. The content criteria 502 or 512 may be user defined criteria thus allowing a user to personalize content that is received via messaging client 500. A communication module 518 is arranged or configured to communicate with the communication module 506 of the messaging client 500. Upon receipt of the personalized or user defined content from the content provider server application 510, the messaging client displays the content to the user via a graphical user interface 508 (e.g., a graphical user interface of an IM client such as AOL IM, MSN IM, or Yahoo IM).

Optional functionality provided in various example embodiments is described by was of example below.

Example Toolbar Alerts

In an example embodiment, the functionality provided by the GUI 50 is provided in a toolbar. The toolbar may be client side software (e.g., part of the messaging client 500) that installs as a plug-in to a user's existing browser (e.g., Windows Explorer, Mozilla Firefox, or the like). The toolbar may provide additional functionality to the browser, including an alerting capability as described herein which provides IM alerts based, for example, on the IM criteria 24. Alerts may be delivered to the end user in the form of a data display, for example, a pop up screen (e.g., a small pop up screen) that emerges with an alert message notifying the user about specific events. These events may triggered by the user's activity on a network-based commerce system. For example, the event may be that the user has been outbid on an auction item listed on the network-based commerce system, the user has been outbid on an item and the auction is approaching completion, or the like. Each alert may include an active hypertext link that allows the user to easily click on it, and be directed to an associated item/listing auction page of a network-based auction facility that will allow the user to take an appropriate or selected action (e.g., place a higher bid).

The toolbar may serve as a client side alternative to other instant messaging client applications (e.g., Yahoo IM, AIM, etc.). In this example instance, the toolbar may allow the user to input and store their current “Watch List” preferences directly into the toolbar on the client side. These preferences may allow the user to determine which alerts will be delivered to them, and the frequency of delivery, as described above.

For example, if a user is seeking a rare collectible, the user may input the title or description for the specific item they are looking for, and if an item matching this description appears for sale on the network-based auction facility, the user may receive an instant message data display alert (e.g., a pop up window, a SMS (Short Message Service), or the like) delivered via the toolbar in the user's browser. The instant message data display alert may allow the user to click on a hypertext link included in the message, and thus take the user to an associated or specific page for the auction item/listing that they indicated they are seeking.

In another example embodiment, the user may input titles, descriptions, or the like of specific items that they are seeking directly (e.g., interested in bidding on) into their “MyFacility” page (e.g., via the IM criteria 24), and store their preferences on the server side (e.g., at the server application 510) within a main user preference database of a network-based commerce system. These centrally stored preferences may initiate alerts to be delivered via the toolbar, or the user's preferred instant messaging client of choice. It will be appreciated that the alerts may also be delivered by any platform or communications channel (e.g., wired or wireless).

Example Instant Messaging Gateway Integration

In an embodiment, a network-based commerce platform may allow propriety integration into each instant messaging service and vice versa. A unique set of integration and system requirements (integration APIs, integration data schema, communication protocol, etc.) may thus be provided for each instant messaging service. Such APIs may enable communication of the alerting message from various different messaging clients to the instant messaging platform of the network-based commerce system and receive confirmations. Furthermore, such APIs might also enable storage and other manipulation of such alerting messages. As mentioned above, example instant messaging services include AOL Instant Messenger (AIM), MSN Messenger, and Yahoo Instant Messenger. In an embodiment, custom integration is provided on an instant messaging platform to understand alerts from the network-based commerce platform.

For example, where alerts from a network-based commerce platform are integrated into Yahoo Instant Messenger, the network-based commerce platform may need to install a messenger SDK (software development kit), for example, the SDK available from eBay Inc. This example SDK may expose Yahoo Messenger APIs to the networked-based commerce platform. When a specific criterion to create an alert is met for a user on the networked-based commerce platform, the alert may be sent to the Yahoo Messenger platform using their API. Also, Yahoo might choose to install the networked-based commerce SDK or directly integrate into an alerts API of the networked-based commerce platform.

Set-Top Cable Boxes

The invention may also be deployed in a set-top box environment. In an embodiment utilizing cable set-top boxes equipped with OCAP functionality (Open Cable Applications Platform) or other similar standards-based cable communication protocols, a network-based commerce system may extend the instant messaging alert functionality to appear via a user's television. Users that may have elected to receive instant message notifications from the network-based commerce system may be able to receive alert messages via their television. The network-based commerce system may integrate its API with cable providers that supports OCAP, or other similar protocols, that allow data Internet Protocol (IP) communications to occur directly between the network-based commerce system and cable set-top boxes. These cable set-top boxes may serve as an alternative destination for instant messaging alerts originating from the network-based commerce system. It will however be appreciated that the invention is not limited to deployment in a cable or set-top box environment, and it may also be deployed in any television distribution channel (e.g., a satellite system) and via any hardware/software provided at a subscriber location.

Wireless Deployment

In a similar fashion to the set-top cable box deployment, alerts functionality can be extended to serve consumers on wireless devices (e.g., cellular telephones via a cellular telephone network). Accordingly, mobile consumers or users can receive IM communications relating to their defined IM criteria 24 while on the road.

Thus, in addition or instead, a wireless device can act as an alternative to the instant messaging service (which may be desktop based and hence not mobile). The network-based commerce platform alert may be sent in a similar fashion to the wireless service provider platform or another enabler service. The alert would then be sent to the end consumer. Such an alert can then be displayed as a SMS text message or be handled by an application running on the wireless platform, which may display it in different ways. Thus, for the purposes of this specification, the term instant message or IM is intended to include any type of communications service that enables a user to communicate in real-time (occurring almost immediately) over the Internet or any other communication channel such as cellular telephone network, analogous to a telephone conversation but using text-based, not voice-based, communication.

In an embodiment, irrespective of the communication platform (e.g., wired and/or wireless Internet, cellular network, or the like), the system 10 may allow an end user to manage their IM criteria 24.

Example Network-Based Commerce Platform Messages: Trust and Safety, Direct Marketing Purposes

In addition to notifications about items listed that match the user's stored list (e.g., IM Criteria 24), the network-based commerce system may send instant messages to users that have elected to receive instant notifications about important Trust and Safety messages (e.g., related to the network-based commerce system). These messages may include notices of a request to change personal information, a notification that an item has been posted on the network-based commerce system under the user's user ID (identification), or the like. Further, a user may elect to be notified about any other platform alerts or direct marketing messages associated with or provided by the network-based commerce system, such as free listing promotions, refer a friend promotion, etc. Thus, messages may be sent alerting a user to any event that the user has identified or subscribed to and the alerts may be via any one or more of a plurality of platforms.

Example Want it Now Messages: Messaging a Match Between Supply and Demand

In an embodiment if a user posts a “want ad” to a network-based commerce system (e.g., eBay Inc.'s Want It Now service), the user may choose to receive an instant message via their preferred messaging client from network-based commerce system when another user posts an item for sale matching their “Want ad” (e.g., defined by their IM criteria 24). The utilization of instant messaging in this example embodiment may allow a network-based commerce system to more effectively match supply to demand in a distributed manner, reaching users even while they are not actively on a website of the network-based commerce system.

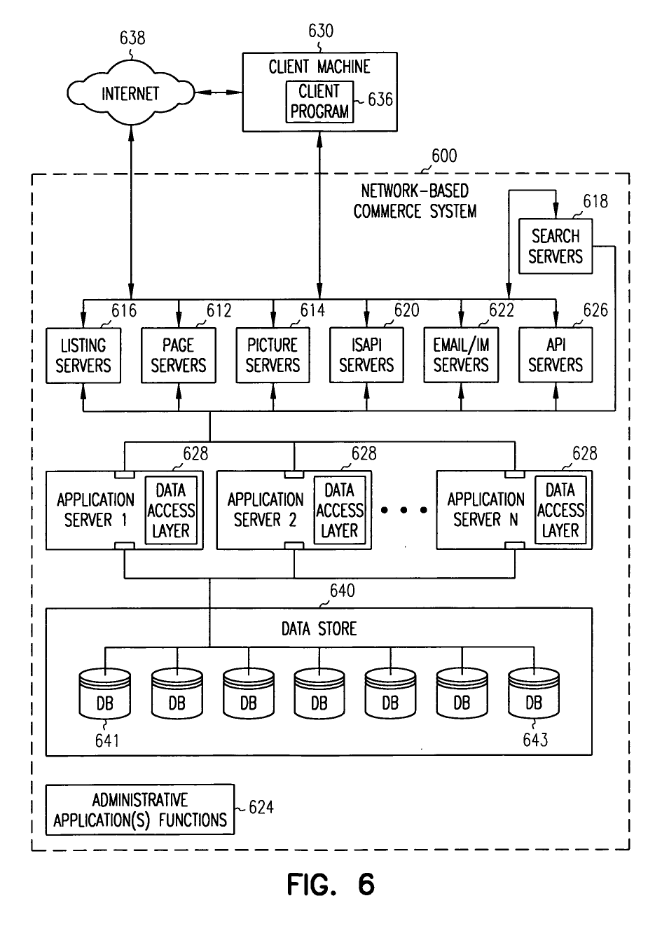

FIGS. 6-10 show example details of the electronic marketplace 16. The example architectures and arrangements provide a few environments in which the embodiments of this invention may usefully be deployed; however, it is noted the embodiments presented above are not intended to be limited or constrained by the specific examples presented below.

FIG. 6 is block diagram illustrating an example network-based commerce system or facility 600 wherein embodiments of the present invention may be deployed. While an example embodiment of the present invention is described within the context of the network-based commerce system 600, the invention will find application in many different types of computer-based, and network-based, facilities (commerce, transaction or otherwise).

The network-based commerce system 600 includes one or more of a number of types of front-end servers that may each include at least one Dynamic Link Library (DLL) to provide selected functionality. The system 600 may include page servers 612 that deliver web pages (e.g., mark-up language documents), picture servers 614 that dynamically deliver images to be displayed within Web pages, listing servers 616 that facilitate category-based browsing of listings, search servers 618 that handle search requests to the system 600 and facilitate keyword-based browsing of listings, and ISAPI servers 620 that provide an intelligent interface to a back-end of the system 600. The system 600 may also include e-mail servers 622 that provide, among other things, automated e-mail communications to users of the network-based commerce system 600. In one example embodiment, the e-mail servers 622 include IM server functionality.

In an embodiment, one or more administrative application functions 624 facilitate monitoring, maintaining, and managing the system 600. One or more API servers 626 may provide a set of API functions for querying and writing to the network-based commerce system 600. APIs may be called through the HTTP transport protocol. In an embodiment, information is sent and received using a standard XML data format. Applications utilized to interact (e.g., upload transaction listings, review transaction listings, manage transaction listings, etc.) with the network-based commerce system 600 may be designed to use the APIs. Such applications may be in an HTML form or be a CGI program written in C++, Perl, Pascal, or any other programming language.

The API servers 626, page servers 612, picture servers 614, ISAPI servers 620, search servers 618, e-mail servers 622 (optionally including IM server functionality) and a database engine server (e.g., provided by one or more of the application servers 628) may individually, or in combination, act as a communication engine to facilitate communications between, for example, a client machine 630 and the network-based commerce system 600; act as a transaction engine to facilitate transactions between, for example, the client machine 630 and the network-based commerce system 600; and act as a display engine to facilitate the display of listings on, for example, the client machine 630.

The back-end servers may include a database engine server, a search index server and a credit card database server, each of which maintains and facilitates access to a respective database.

In an embodiment, the network-based commerce system 600 is accessed by a client program, such as for example a browser 636 (e.g., the Internet Explorer distributed by Microsoft Corp. of Redmond, Wash.) that executes on the client machine 630 and accesses the network-based commerce system 600 via a network such as, for example, the Internet 638. Other examples of networks that a client may utilize to access the network-based commerce system 600 include a wide area network (WAN), a local area network (LAN), a wireless network (e.g., a cellular network), the Public Switched Telephone Network (PSTN) network, or the like. The client program that executes on the client machine 630 may also communicate with the network-based commerce system 600 via the API servers 626.

### Example Database Structure

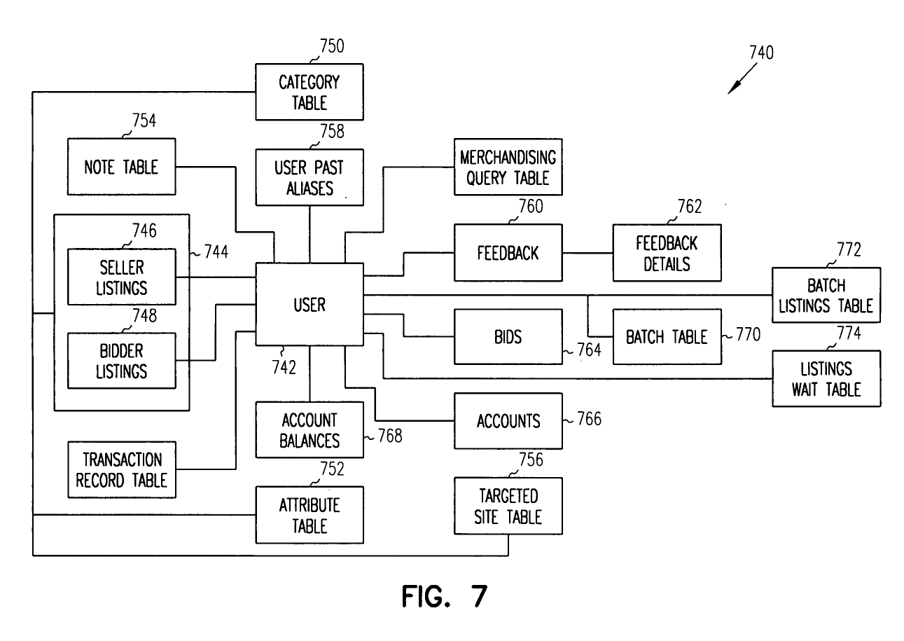

FIG. 7 is a database diagram illustrating an example database 740, maintained by and accessed via the database engine server 728, which at least partially implements and supports the network-based commerce system 700. In an embodiment a database engine server may maintain a plurality of databases 740. For example, may maintain a master write database 741 (e.g., including a plurality of horizontally distributed databases), and a read-only database 743 that may, for example, allow loads to be balanced appropriately.

The database 740 may, in an embodiment, be implemented as a relational database, and includes a number of tables having entries, or records, that are linked by indices and keys. In an alternative embodiment, the database 740 may be implemented as collection of objects in an object-oriented database.

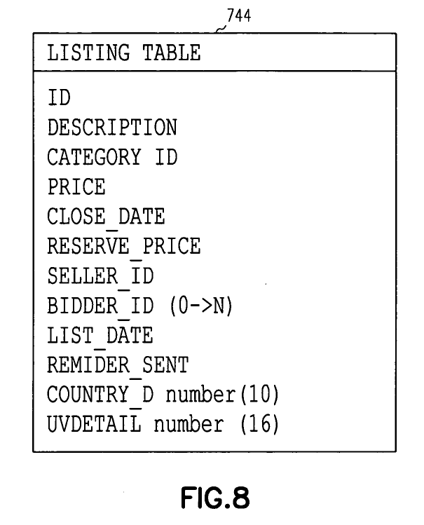

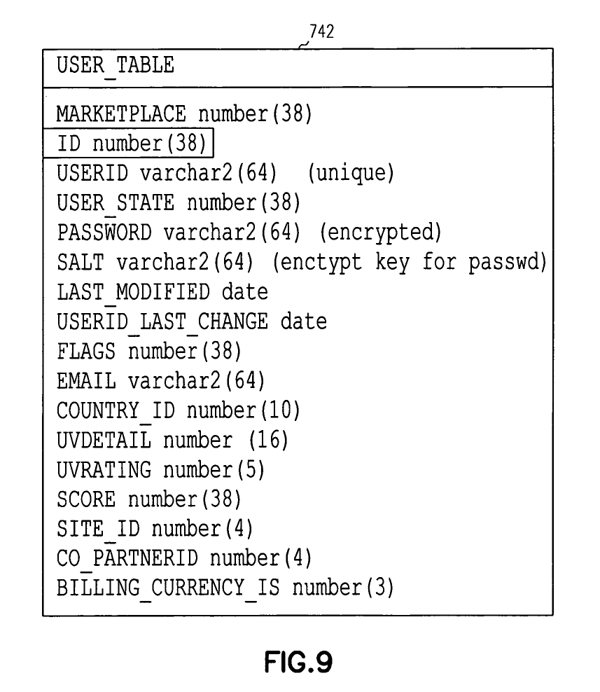

The database 740 includes a user table 742 that contains a record for each user of the network-based commerce system 700. An example record for each user is shown in FIG. 9. A user may operate as a seller, a buyer, or both, when utilizing the network-based commerce system 700. The database 840 also includes listings tables 744 (see FIGS. 8 and 9) that may be linked to the user table 742. The listings tables 744 may include a seller listings table 746 and a bidder listings table 748. A user record in the user table 742 may be linked to multiple listings that are being, or have been, listed or offered for sale via the network-based commerce system 700. In an embodiment, a link indicates whether the user is a seller or a bidder (or buyer) with respect to listings for which records exist within the listings tables 744.

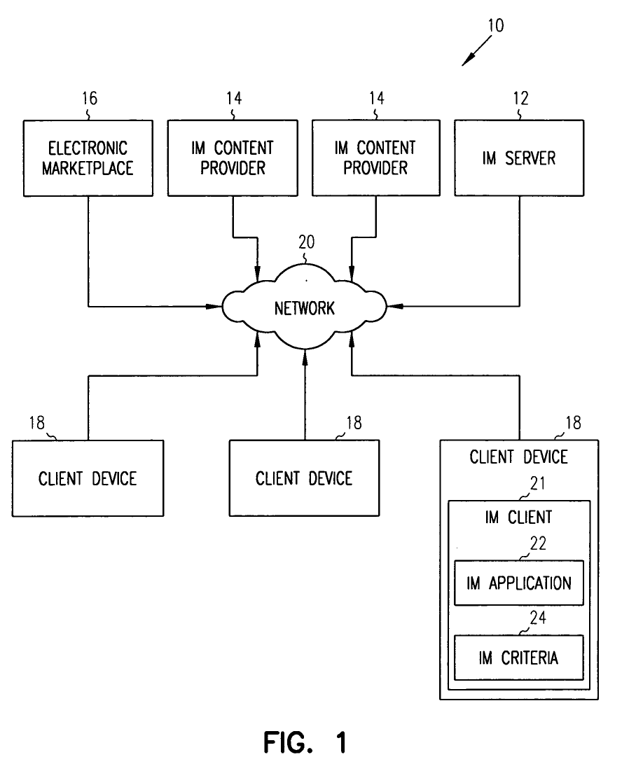

The database 740 also includes one or more divisions in the form of categories provided in category tables 750. Each record within the category table 750 may describe a respective category. In an embodiment, listings provided by the system 700 are arranged in the categories. These categories may be navigable by a user of the network-based commerce system 700 to locate listings in specific categories. Thus, categories provide a mechanism to locate listings that may be browsed. In addition or instead, an alphanumeric search mechanism may be provided by the search servers 718 to allow a user to search for specific listings using search terms or phrases. In one example embodiment, search terms provided by an IM client (e.g., the IM client 21 shown in FIG. 1) may be used to locate listings.

The category table 750 may describe multiple, hierarchical category data structures, and includes multiple category records, each of which describes the context of a particular category within the multiple hierarchical category structures. For example, the category table 750 may describe a number of real, or actual, categories to which listing records, within the listings tables 744, may be linked.

The database 740 is also shown to include one or more attributes tables 752. Each record within the attributes table 752 describes a respective attribute associated with a listing. In an embodiment, the attributes table 752 describes multiple, hierarchical attribute data structures, and includes multiple attribute records, each of which describes the context of a particular attribute within the multiple hierarchical attribute structures. For example, the attributes table 752 may describe a number of real, or actual, attributes to which listing records, within the listings tables 744, may be linked. Also, the attributes table 752 may describe a number of real, or actual, attributes to which categories, within the category table 750, may be linked. In an embodiment, the IM criteria 24 may include attributes to facilitate location of appropriate listings in the database 740.

The database 740 may also include a note table 754 populated with note records that may be linked to one or more listing records within the listings tables 744 and/or to one or more user records within the user table 742. Each note record within the note table 754 may include, among other things, a comment, description, history or other information pertaining to a listing being offered via the network-based commerce system 700, to a user of the network-based commerce system 700. The database 740 may also include a targeted site table 756 populated with targeted site records that may be linked to one or more listing records within the listings tables 744 and/or to one or more user records within the user table 742.

A number of other example tables may also be linked to the user table 742, namely a user past aliases table 758, a feedback table 760, a feedback details table 762, a bids table 764, an accounts table 766, and an account balances table 768. In an embodiment, the database 740 also includes a batch table 770, a batch listings table 772, and a listings wait table 774. The data may be partitioned across multiple database instances, and queries may have to be executed against multiple database instances and query results may need to be aggregated.

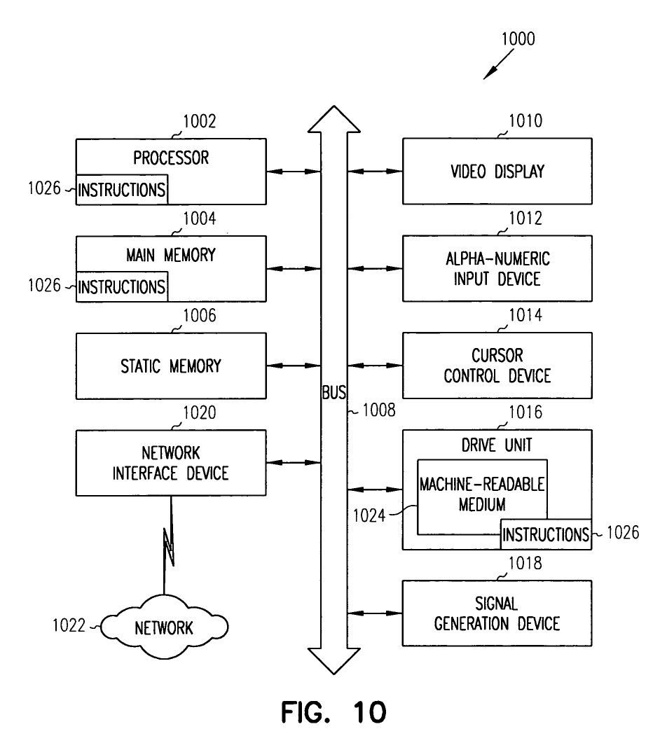

FIG. 10 shows a diagrammatic representation of a machine in the example form of a computer system 1000 within which a set or sequence of instructions, for causing the machine to perform any one of the methodologies discussed herein, may be executed. In alternative embodiments, the machine may comprise a network router, a network switch, a network bridge, Personal Digital Assistant (PDA), a cellular telephone, a web appliance, set-top box (STB) or any machine capable of executing a sequence of instructions that specify actions to be taken by that machine.

The computer system 1000 includes a processor 1002, a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a disk drive unit 1016, a signal generation device 1018 (e.g., a speaker) and a network interface device 1020 to interface the computer system to a network 1022.

The disk drive unit 1016 includes a machine-readable medium 1024 on which is stored a set of instructions or software 1026 embodying any one, or all, of the methodologies described herein. The software 1026 is also shown to reside, completely or at least partially, within the main memory 1004 and/or within the processor 1002. The software 1026 may further be transmitted or received via the network interface device 1020.

For the purposes of this specification, the term “machine-readable medium” shall be taken to include any medium which is capable of storing or encoding a sequence of instructions for execution by the machine and that cause the machine to perform any one of the methodologies of the present invention. The term “machine-readable medium” shall accordingly be taken to include, but not be limited to, solid-state memories, optical and magnetic disks, and carrier wave signals. Further, while the software is shown in FIG. 10 to reside within a single device, it will be appreciated that the software 1026 could be distributed across multiple machines or storage media, which may include the machine-readable medium.

It should also be noted that in some embodiments the methods 100, 200, and 300 may be implemented on a machine-accessible medium having instructions. The instructions when executed by a machine perform the methods 100, 200, and 300. The medium may be removable media that is interfaced to the machine. Alternatively, the medium may be fixed media that is an integral part of the machine. In this manner, the instructions of the methods 100, 200, and 300 may be pressed on removable media and uploaded to a machine, preloaded within a machine, downloaded on a machine from a peripheral device, or downloaded from a remote machine over a network to a different machine.

The above description is illustrative, and not restrictive. Many other embodiments will be apparent to those of ordinary skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A method to provide content via an instant messaging client to a user, the method including:
at a content provider, receiving content identification criteria defined by a user;
retrieving content identified by the content identification criteria; and
automatically communicating the content via an instant message to the instant messaging client.

2. The method of claim 1, wherein the content identification criteria are stored at the instant messaging client, the method including receiving the content identification criteria from the instant messaging client.

3. The method of claim 2, which includes receiving at an instant messaging server an HTML request including the content identification criteria.

4. The method of claim 1, wherein the content provider is a network-based commerce facility providing content in the form of a plurality of listings, the method including:
receiving content identification criteria in the form of listing identification criteria;
executing a search query using the listing identification criteria to identify to associated listings;
communicating the listings via the instant message to the instant message client.

5. The method of claim 1, wherein the content identification criteria are selected from the group including at least one search term, at least one listing on a watch list, at least one listing category, at least one seller identifier, a number of listings, a refresh rate, and stored preferences.

6. The method of claim 1, which includes communicating the instant message via at least one of the Internet, a cellular telephone network, and a television distribution channel.

7. The method of claim 1, which includes communicating the instant message as an SMS (Short Message Service) message via a cellular telephone network to a cellular telephone.

8. A machine-readable medium embodying instructions which, when executed by the machine, cause the machine to perform the method of claim 1.

9. An instant messaging server including at least one application module to perform the method of claim 1.

10. A method of receiving content at an instant messaging client, the method including:
retrieving content identification criteria stored at the instant messaging client;
communicating the content identification criteria via the instant messaging client to an instant messaging server arranged to provide content associated with the content identification criteria;
receiving the associated content from the instant messaging server via an instant message; and
displaying the content via the instant messaging client.

11. The method of claim 10, wherein the content identification criteria are stored in a cookie at the instant messaging client, the method including obtaining the content identification criteria from the cookie for communication to the instant messaging server.

12. The method of claim 10, which includes generating an HTML request including the content identification criteria and communicating the HTML request to the instant messaging server.

13. The method of claim 10, which includes communicating the content identification criteria when the instant messaging client is opened.

14. The method of claim 10, which includes receiving the instant message via at least one of the Internet, a cellular telephone network, and a television distribution channel.

15. The method of claim 10, which includes receiving the instant message as an SMS (Short Message Service) message via a cellular telephone network at a cellular telephone.

16. A machine-readable medium embodying instructions which, when executed by the machine, cause the machine to perform the method of claim 10.

17. An instant massaging client for receiving content, the client including:
a retrieval module to retrieve content identification criteria stored at the instant messaging client;
a communication module to communicate the content identification criteria via the instant messaging client to an instant messaging server arranged to provide content associated with the content identification criteria, and to receive the associated content from the instant messaging server via an instant message; and
a display module to generate a graphical user interface to display the content via the instant messaging client.

18. The instant massaging client of claim 17, wherein the content identification criteria are stored in a cookie, the retrieval module obtaining the content identification criteria from the cookie for communication to the instant messaging server.

19. The instant massaging client of claim 17, which generates an HTML request including the content identification criteria and communicates the HTML request to the instant messaging server.

20. The instant massaging client of claim 17, wherein the content identification criteria are communicated to the instant messaging server when the instant messaging client is opened.

21. The instant massaging client of claim 17, wherein the content identification criteria are selected from the group including at least one search term, at least one listing on a watch list, at least one listing category, at least one seller identifier, a number of listings, a refresh rate, and stored preferences.

22. An instant messaging server to provide content via an instant messaging client to a user, the server including:
means for receiving content identification criteria defined by a user;
means for retrieving content identified by the content identification criteria; and
means for automatically communicating the content via an instant message to an instant messaging client.

23. A method of receiving content at a real-time messaging client, the method including:
retrieving content identification criteria stored at the real-time messaging client;
automatically communicating the content identification criteria via the real-time messaging client to a content server arranged to provide content associated with the content identification criteria;
receiving the associated content via a real-time message; and
automatically displaying the content via the real-time messaging client.

24. The method of claim 23, wherein the content identification criteria are communicated to the content server via a Really Simple Syndication (RSS) message.

25. The method of claim 23, which includes communicating the content identification criteria when the real-time messaging client is opened.
